(19) United States
(12) Patent Application Publication
(10) Pub. No.: US 2026/0220696 A1
(43) Pub. Date: Jul. 30, 2026

(54) AI-POWERED VIRTUAL WARDROBE ASSISTANT

(71) Applicant: eBay Inc., San Jose, CA (US)

(72) Inventor: Amitis Karami, Campbell, CA (US)

(21) Appl. No.: 19/038,868

(22) Filed: Jan. 28, 2025

(51) Int. Cl. G06Q 30/0601; G06Q 30/0282; G06Q 50/00

(52) U.S. Cl. CPC G06Q 30/0643; G06Q 10/40; G06Q 30/0282; G06Q 30/0627

(57) ABSTRACT

Systems and methods are directed to managing a digital wardrobe using machine learning technology. A wardrobe assistant system receives, via a mobile device of a user, a live video of a plurality of fashion items. Each fashion item of the plurality of fashion items in the live video is identified. The wardrobe assistant system determines details for each fashion item in substantially real-time, whereby the details include a description of each identified fashion item. One of the details can be overlaid over at least one fashion item in the live video. The wardrobe assistant system stores the plurality of fashion items and their corresponding details in a digital wardrobe associated with the user. Subsequently, a style model generates a matched style outfit using two or more of the plurality of fashion items from the digital wardrobe and the matched style outfit is displayed in a user interface.

### TECHNICAL FIELD

The subject matter disclosed herein generally relates to machine learning models. Specifically, the present disclosure addresses systems and methods that uses artificial intelligence (AI) and machine learning technology to provide virtual wardrobe assistance.

### BACKGROUND

Typically, users purchase fashion items because they are a good deal or the users like the fashion items. However, the users often do not think about how the fashion items will match what they current own, or the users have a lack of occasion to wear the fashion items. This can result in an overcrowded wardrobe in which the users can lose track of their fashion items and/or do not know how to match fashion items given a large number of fashion items in the wardrobe. Additionally, if a user wants to sell a fashion item that they no longer want, the selling process can be time consuming and computationally expensive.

### BRIEF DESCRIPTION OF THE DRAWINGS

FIG. 1 is a diagram illustrating an example network environment suitable for AI-powered virtual wardrobe assistant using machine learning technology, according to example embodiments.

FIG. 2 is a diagram illustrating components of a wardrobe assistant system, according to example embodiments.

FIG. 3A-FIG. 3G illustrate example user interfaces showing operations associated with the wardrobe assistant system, according to example embodiments.

FIG. 4 is a flowchart illustrating a method for onboarding items into a network system performed at a client device, according to example embodiments.

FIG. 5 is a flowchart illustrating a method for onboarding items performed at the network system, according to example embodiments.

FIG. 6 is a flowchart illustrating a method for providing digital wardrobe assistance in generating outfits, according to example embodiments.

FIG. 7 is a flowchart illustrating a method for handling a non-matching fashion item, according to example embodiments.

FIG. 8 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that use artificial intelligence to manage a digital wardrobe are discussed herein. Example embodiments provide an efficient and simple way to onboard fashion items into the digital wardrobe by scanning of an environment containing fashion items and capturing images of each fashion item. The image of each fashion item being onboarded is analyzed to identify the fashion item and its corresponding metadata or details in substantially real-time. One or more of the item aspect (details) can then be incorporated into an overlay that is displayed over the scan of the environment (e.g., a live video) relative to the fashion item(s) corresponding to the one or more details. Additionally, the identified fashion items and corresponding metadata are stored to the digital wardrobe of a user.

Subsequently, the user can trigger generation of an outfit that matches a particular style (referred to herein as a “matched style outfit). In example embodiments, a prompt is generated that includes instructions to generate the matched style out, information regarding the digital wardrobe (e.g., the fashion items and metadata), and preferences of the user. In some cases, the prompt can indicate the style for the matched style outfit. In some cases, the style is associated with a fashion item that is selected from the digital wardrobe. The prompt is then provided to a machine learning model, which generates one or more matched style outfits. The machine learning model is trained to not only generate the matched style outfits but can also be trained to identify a style of the user (e.g., based on explicit and implicit preferences (e.g., an onboarding survey), past likes and dislikes of generated matched style outfits, and styles of fashion items in their digital wardrobe). Based on user feedback on generated matched style outfits, the machine learning model can be retrained (e.g., the model updates and refines its predictions of matched style outfits). As a result, example embodiments provide a technical solution to the problem of managing a wardrobe and proving a wardrobe assistant.

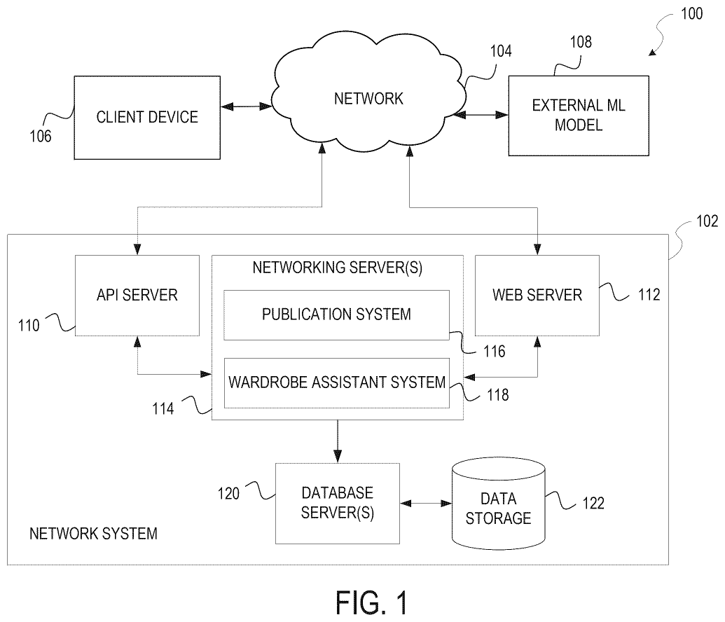

FIG. 1 is a diagram illustrating an example network environment 100 suitable for AI-powered virtual wardrobe assistant using ML technology, according to example embodiments. A network system 102 provides server-side functionality via a communication network 104 (e.g., the Internet, wireless network, cellular network, or a Wide Area Network (WAN)) to a client device 106. The network system 102 is configured to onboard items including fashion items and provide virtual wardrobe assistance, as will be discussed in more detail below.

In various cases, the client device 106 is a device associated with a user of the network system 102. For example, the client device 106 can be a device associated with a user that uses the network system 102 to generate outfits comprising two or more fashion items stored in their digital wardrobe. In some cases, the user captures, using an image capture device (e.g., a camera) of the client device 106, a live video of a plurality of items that include the fashion items. In some cases, the image capture device can also capture a live image of the user in a mirror. The live video and/or the live image, along with any style information provided by the user, can then be transmitted, via the network 104, to the network system 102 for processing, as will be discussed in more detail below.

The client device 106 may comprise, but is not limited to, a smartphone, a tablet, a laptop, multi-processor systems, microprocessor-based or programmable consumer electronics, a desktop computer, a server, or any other communication device that can access the network system 102. The client device 106 can include an application that exchanges data, via the network 104, with the network system 102. For example, the application can be a browser application or a local version of an application associated with the network system 102 that can provide data to, and access data from, one or more components at the network system 102.

In example embodiments, the client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

An external machine learning (ML) model 108 is a third-party model or artificial intelligence (AI) that processes data on behalf of the network system 102 (e.g., GPT4). In some embodiments, the external ML model 108 generates matched style outfits on behalf of the network system 102 based on a prompt that is generated by the network system 102, as will be discussed in more detail below. It is noted that if the network system 102 comprises an internal ML model, then the external ML model 108 is not necessary.

Turning specifically to the network system 102, an application programing interface (API) server 110 and a web server 112 are coupled to and provide programmatic and web interfaces respectively to one or more networking servers 114. The networking servers 114 host various systems including a publication system 116 and a wardrobe assistant system 118, each comprising a plurality of components and each of which can be embodied as a combination of hardware, software, and/or firmware. The networking servers 114 can comprise other system based on the nature of the network system 102.

The publication system 116 is configured to manage publications (e.g., articles, documents, publications (e.g., listings) of available goods or services) and transactions at the network system 102 including generating and publishing the publications, conducting searches for publications, and/or maintaining user accounts of users of the network system 102. In example embodiments, the publications can be for fashion items that the user is either interested in acquiring or for fashion items that the user wants to sell, as will be discussed in more detail below.

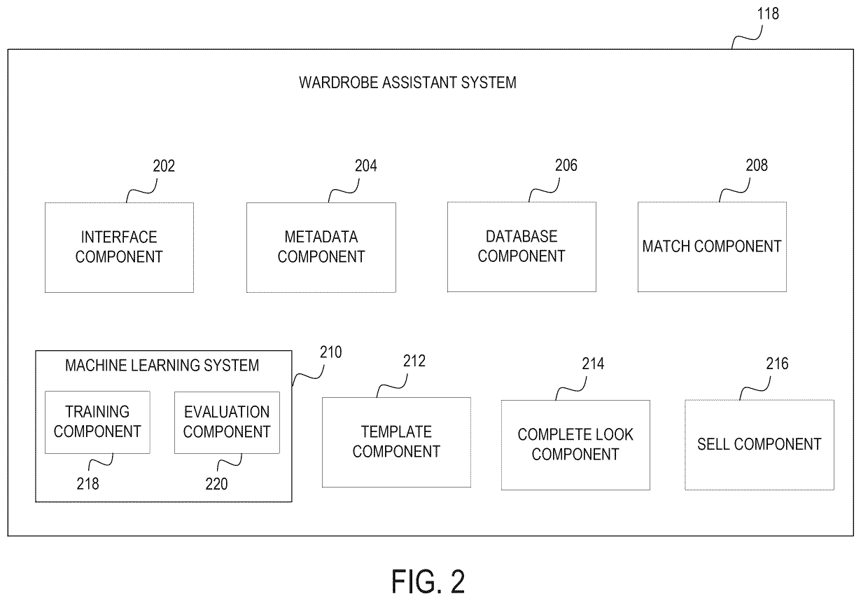

The wardrobe assistant system 118 is configured to onboard fashion items into a digital wardrobe for the user and generate matched style outfits based on different styles associated with the user and their digital wardrobe. The wardrobe assistant system 118 can also recommend fashion items based on one or more fashion items in the digital wardrobe and/or assist in listing a fashion item from the digital wardrobe that the user no longer wants or needs. The wardrobe assistant system 118 will be discussed in more detail in connection with FIG. 2 below.

The networking servers 114 can be, in turn, coupled to one or more database servers 120 that facilitate access to one or more storage repositories or data storage 122. The data storage 122 is a storage device storing, for example, user accounts including user profiles of users of the network system 102, different fashion styles that are associated with each user, and the onboarded fashion items associated with each user.

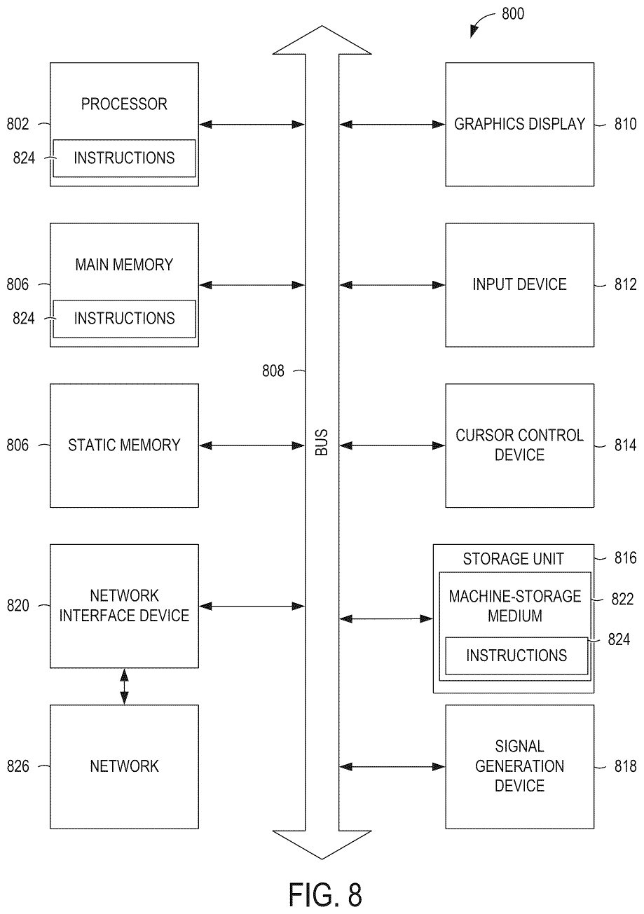

Any of the systems, data storage, servers, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 8, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one component may, in alternative examples, be embodied in a different component. Additionally, any number of client devices 106 and data storage 122 may be embodied within the network environment 100. While only a single network system 102 is shown, alternatively, more than one network system 102 can be included (e.g., localized to a particular region).

FIG. 2 is a diagram illustrating components of the wardrobe assistant system 118, according to example embodiments. In example embodiments, the wardrobe assistant system 118 comprises a server that manages digital wardrobes for users of the network system 102 and generation of outfits that match a fashion style associated with each user using artificial intelligence (AI) and machine learning technology, such as large language model (LLM) technology. The wardrobe assistant system 118 can also be trained to learn the fashion styles associated with each user and/or fashion item. To enable these operations, the wardrobe assistant system 118 can comprise an interface component 202, a metadata component 204, a database component 206, a prompt component 208, a machine learning system 210, a template component 212, a complete look component 214, and a sell component 216 configured in communication with one another (e.g., via a bus, shared memory, or a switch).

The interface component 202 is configured to exchange data with the client device 106 including managing user interfaces and/or overlays that are displayed on the client device 106. In example embodiments, the interface component 202 can receive inputs from the client device 106 and cause presentation of information on the user interface. For example, the interface component 202 can receive live video captured by the client device 106 of items to be onboarded to an account of the user at the network system 102. In some cases, the user may indicate a style associated with one or more fashion items being onboarded. Additionally, the interface component 202 can receive a live video or image of the user (e.g., captured in a mirror). The live video or the image of the user can then be used to display a matched style outfit thereon. In example embodiments, the interface component 202 includes an imaging component that can move the matched style outfit positioned on the image of the user as the user moves in the mirror. In some cases, the interface component 202 can also display the matched style outfits on a still image of the user (e.g., captured in the mirror) or on an avatar (e.g., that is selected by the user) that represents a body type or look of the user.

The interface component 202 can also receive user selection of options associated with fashion items displayed on a user interface on the client device 106. The user selections can include operations to be performed with one or more of the fashion items including generating matched style outfits (or further matched style outfits), selling fashion items that do not match styles of other fashion items in the user's wardrobe, or purchasing one or more fashion items that match in style with a fashion item in the user's wardrobe.

The metadata component 204 is configured to manage metadata (also referred to as “details” or “item attributes”) associated with each fashion item that is onboarded into the user's wardrobe. In example embodiments, as each fashion item is being captured in the live video, the metadata component 204 identifies each fashion item in the video and determines corresponding metadata or details about each fashion item. Specifically, the metadata component 204 processes an image of each fashion item to identify the fashion item. In some embodiments, the image of a fashion item can be compared to a database of images of identified fashion items (e.g., stored in the data storage 122) to find a closest match. Once the closest match is identified, corresponding metadata for the matched identified fashion item is accessed and associated with the fashion item in the live video. The metadata can include, for example, a stock image, a category, an item type, colors, textures, material (e.g., cotton, denim, leather, silk, wool), patterns (e.g., plain, striped, checkered, floral), a brand, a price (e.g., average sales price, manufacturer recommended price), a corresponding style (e.g., casual, preppy, streetwear), a fit (e.g., loose, tight, oversized, cropped), a season (e.g., summer, winter), and/or any other type of attribute that describes the fashion item. The metadata can also include accessories that would go with the fashion item (e.g., hat, jewelry, bag, belt). By tagging the fashion items with these metadata or attributes, the machine learning model or AI can more easily learn how pieces from various categories (e.g., a casual t-shirt and a preppy blazer) can be combined.

In alternative embodiments, the fashion item and corresponding metadata can be identified using the machine learning system 210. In these embodiments, the metadata component 204 generates a prompt using the image of the fashion item and triggers the machine learning system 210, which comprises a machine learning model that is trained on images of fashion items and their corresponding metadata. The machine learning system 210 can then identify (e.g., predict) the fashion item and provide an indication of the fashion item and its metadata to the metadata component 204 and/or the database component 206.

In some embodiments, one or more details or metadata determined by the metadata component 204 and/or the machine learning system 210 can be displayed to the user in substantially real-time. For example, the interface component 202 receives one or more details and generates an overlay with the one or more details to be positioned over the corresponding fashion item in the live video. For instance, a name of the fashion item or a price of the fashion item can be overlaid over the image of the corresponding fashion item in the live video.

The database component 206 is configured to manage the onboarded fashion items, preferences of the user, and style templates. In example embodiments, the database component 206 stores the metadata for each fashion item in the user's digital wardrobe (e.g., to a user profile of the user). The database component 206 can access the digital wardrobe when the wardrobe assistant system 118 is triggered to generate matched style outfits. Similarly, the database component 206 can store user styles to their user profile and access the user styles when the wardrobe assistant system 118 is triggered to generate matched style outfits.

In some embodiments, the wardrobe assistant system 118 utilizes style templates. Each style template indicates information about a particular style. For example, a winter template may include information regarding the type of fashion items that are typically worn in winter (e.g., fur lined boots, parkas, flannels). As another example, an 80's template can include information regarding the type of fashion items worn in the 1980s (e.g., leg warmers, neon colors, parachute pants), while a latest trend template can include information regarding the current trending fashion items. In some embodiments, the style templates are generated by the wardrobe assistant system 118, as will be discussed in more detail below. These style templates can be stored (e.g., to the data store 122) and are accessed by the database component 206 when, for example, the wardrobe assistant system 118 is triggered to generate matched style outfits.

The match component 208 is configured to manage generating matched style outfits. In example embodiments, the match component 208 generates a prompt for triggering a machine learning model to generate one or more matched style outfits. When the interface component 202 receives a user indication to generate matched style outfits, the match component 208 is triggered to generate the prompt. In embodiments where a machine learning model (also referred to herein as a “style model”) is trained on different styles, the prompt can include, for example, an indication to generate one or more matched styles using the user's digital wardrobe, an indication of the fashion items in the digital wardrobe, and any user preferences. The user preferences can include styles or previously generated outfits that the user has indicated as not liking or liking. These user preferences can be learned by the machine learning model and associated with an account of the user.

In some cases, the prompt can also include a fashion item selected from the digital wardrobe that should be included in the matched style outfit (e.g., a fashion item that the user indicated they wanted to wear). Additionally or alternatively, in some cases, the prompt can also include an indication of a style that the user is interested in or an event that the user is attending. For example, the user may want to generate a 1990's style outfit, an outfit to wear to afternoon tea, or an outfit that is based on a burgundy color. In some cases, the style can be based on a season (e.g., winter style), a day of the week (e.g., weekday work style, Sunday church style), or an occasion.

In embodiments where the machine learning model is not already trained on styles, the prompt can also include, for example, an indication to generate one or more matched styles using the user's digital wardrobe, an indication of the fashion items in the digital wardrobe, any user preferences, and a style template retrieved by the database component 206. The style template can be for a style associated with a fashion item selected from the digital wardrobe that should be included in the matched style outfit or can be associated with an indicated style that the user is interested in (e.g., for an event that the user is attending). For example, if the user is going to opening night at the opera, the style template can be a formal attire template.

The prompt is used to trigger the machine learning model to generate the one or more matched style outfits. Thus, the prompt is provided to the machine learning system 210. The results of the machine learning system 210 can be provided back to the match component 208. In example embodiments, the match component 208 works with the interface component 202 to display the results in user interfaces.

The user can indicate whether they like the one or more matched style outfits, do not like the one or more matched style outfits, or if they want more outfits generated. When the user indicates a like or dislike, the match component 208 registers that indication and can update user preferences (e.g., stored to the user profile). For example, the user preference can indicate to never show the disliked outfit and/or corresponding style again. Conversely, if the user likes a generated outfit, the user preferences can be updated to indicate a preference for outfit and/or the style associated with the liked outfit.

Additionally, if the user indicates a like, the match component 208 can assume that the user is wearing the liked matched style outfit. The match component 208 can register use of the fashion items in the liked matched style outfit. In some embodiments, the match component 208 can include in the prompt usage information for each fashion item and request the machine learning model generate matched style outfits that use fashion items that have not been worn as often. By doing use, the wardrobe assistant system 118 can attempt to provide better usage of all fashion items in the digital wardrobe. In some cases, the usage information can be used to trigger the selling of an underutilized fashion item.

In some embodiments, the match component 208 provides a virtual try-on service in which a matched style outfit is displayed on an image of the user. In some cases, a live video or image of the user in the mirror is captured and accessed by the interface component 202. The matched style outfit is displayed on the user in the live video or image. For example, an imaging component of the interface component 202 positions (e.g. overlays) the matched style outfit on the live video or image of the user and can move the matched style outfit as the user moves in the mirror. In other cases, the user can select an avatar that has a similar body shape or look as the user, and the interface component 202 can display the matched style outfit on the avatar or on a still image of the user (e.g., captured in the mirror).

In some embodiments, the match component 208 can also post the matched style outfit to a social network indicated by the user. For example, the match component 208 can position the matched style outfit on an image or video of the user and generate a post that is transmitted to a social networking system. The post can elicit feedback from other users of the social network. The match component 208 can then present the feedback to the user (e.g., via a user interface generated by the interface component 202).

The machine learning system 210 is configured to train one or more machine learning (ML) models and to use the ML models to generate matched style outfits, identify metadata associated with fashion items, and/or generate user preferences (e.g., a user style). The machine learning system 210 can comprise a training component 218 and an evaluation component 220.

In some embodiments, the training component 218 trains a machine learning model to predict a style for a new fashion item that is being onboarded, matched style outfits, and/or generate/refine style templates. In these embodiments, the training component 218 gathers a large dataset of images of fashion items and descriptions for different styles (e.g., for an era). For example, for the 1980s, the training component 218 collects images of fashion items from the 1980s. The dataset is transformed into features such as, for example, specific patterns, colors, silhouettes, and other stylist elements that are characteristic of each style. Using machine learning algorithms, such as Convolutional Neural Networks (CNNs) for image recognition or Natural Language Processing (NLP) for text data, the machine learning model is trained on the features. This can be done with each style (e.g., each era, each style type such as Goth, formal attire, beachy summer, winter ski lodge). Thus, the machine learning model learns to recognize distinctive attributes of each style. This model can then be used to identify a style and corresponding metadata for each fashion item being onboarded. Additionally, this model can be used to generate matched style outfits since the model is trained on different styles and what attributes are associated with each style. Further still, since the machine learning model has been trained on the different styles, the model can generate a style template for each style if needed.

In some embodiments, the machine learning model is also trained to predict a style of the user. In these embodiments, the training component 218 gathers data on the individual's style preferences. This can include the fashion items already in the user's digital wardrobe and matched style outfits that the user has liked or disliked in the past. The dataset is transformed into features such as, for example, specific patterns, colors, silhouettes, and types of clothing. Using machine learning algorithms, such as Convolutional Neural Networks (CNNs) for image recognition or Natural Language Processing (NLP) for text data, the machine learning model is trained on the features. Thus, the machine learning model is trained to predict the user's style based on new data and can, for example, suggest new fashion items and new matched style outfits based on the user's preferences. Further still, the training component 218 can retrain the machine learning model and/or refine the user style based on each addition matched style outfit that the user indicates as liking or disliking resulting in refined predictions for future matched style outfits. In some embodiments, the user preferences can be embodied in a user style template that can be used in generating future matched style outfits.

The evaluation component 220 is configured to determine a style of an onboarded fashion item, a style of the user, and/or matched style outfits. In example embodiments, the evaluation component 220 triggers the machine learning model using the prompts generated by the match component 208. The evaluation component 220 can return the predicted style of an onboarded fashion item, the predicted style of the user, and/or the generated matched style outfit(s) to the match component 208 and/or the interface component 202.

In some embodiments, during a sign-up process, users are asked about their style preferences, which can be fed into machine learning system 210 (e.g., an artificial intelligence (AI)) using the same set of data. With these style preferences and continuous AI-generated data, the machine learning system 210 can curate the best outfit matches tailored to each individual. The following table provides a breakdown of some different fashion styles that can guide the machine learning system 210 in making personalized outfit recommendations. In some cases, the different fashion styles are associated with a corresponding style template that can be used by the machine learning system 210.

| | | | | COLOR/ |
|---|---|---|---|---|
| STYLES | DESCRIPTION | KEY PIECES | ACCESSORIES | PATTERNS |
| Casual | Comfortable, | Jeans, t-shirts, | Simple bags, | Neutral colors, |
| | relaxed, and | hoodies, sweaters, | caps, watches. | solid colors, |
| | easy-to-wear. | casual shoes, | | stripes, basic |
| | | sneakers. | | prints. |
| Streetwear | Urban-inspired | Oversized t-shirts, | Baseball caps, | Bold graphics, |
| | style with | graphic tees, | chain necklaces, | logos, |
| | influences from | hoodies, sneakers | backpacks. | monochromatic |
| | skate culture, | (e.g., Jordans, | | with pops of |
| | hip hop, and | Vans), cargo | | color, camo. |
| | high fashion. | pants. | | |
| Business | A polished yet | Button-up shirts, | Simple jewelry, | Neutral tones, |
| Casual | comfortable | blouses, chinos, | belts, structured | pastels, |
| | style suitable | skirts, blazers, | bags. | pinstripes, plaid, |
| | for work but | loafers. | | small prints. |
| | not as formal as | | | |
| | corporate attire. | | | |
| Formal | Professional | Suits, dress shirts, | Watches, | Dark, muted tones |
| (Business/ | and | dress shoes, | briefcases, | (black, navy, |
| Formal) | sophisticated | formal dresses, | cufflinks, ties, | gray), solid |
| | attire for office | blazers, ties. | pocket squares. | colors, subtle |
| | and formal | | | patterns like |
| | settings. | | | houndstooth or |
| | | | | pinstripes. |
| Bohemian | Free-spirited, | Maxi skirts, | Layered | Earth tones, |
| | laid-back, and | peasant blouses, | necklaces, | floral prints, |
| | eclectic style | fringe jackets, | scarves, ethnic | ethnic and tribal |
| | with artistic, | flowy dresses, | jewelry, floppy | patterns, tie-dye. |
| | vintage | wide-brim hats. | hats, sandals. | |
| | influences. | | | |
| Preppy | Inspired by Ivy | Polo shirts, | Leather belts, | Pastels, plaids, |
| | League fashion; | chinos, blazers, | simple watches, | stripes, solid |
| | clean-cut, | cardigans, boat | headbands, | colors, nautical |
| | polished, and a | shoes. | scarves. | motifs. |
| | bit traditional. | | | |
| Minimalist | Simple, clean, | Tailored trousers, | Simple jewelry, | Black, white, |
| | and functional | plain white shirts, | sleek bags, | neutral tones, |
| | clothing with an | basic tees, | minimalist | geometric |
| | emphasis on | monochrome | shoes. | patterns. |
| | quality over | sweaters, | | |
| | quantity. | structured jackets. | | |
| Athleisure | A blend of | Leggings, joggers, | Gym bags, | Bold, vibrant |
| | athletic wear | sports bras, | sporty watches, | colors, |
| | and casual style | sneakers, hoodies, | baseball caps, | monochromatic, |
| | for comfort and | tracksuits. | athletic | or sporty stripes. |
| | style. | | | |
| Gothic | Dark, edgy, and | Black leather, | Black leather, | Black, deep reds, |
| | sometimes | lace, corsets, | lace, corsets, | purples, |
| | mysterious, | ripped jeans, | ripped jeans, | occasional dark |
| | often with | combat boots, | combat boots, | metallics. |
| | Victorian or | dark hoodies. | dark hoodies. | |
| | punk | | | |
| | influences. | | | |
| Vintage/ | Clothes | High-waisted | Cat-eye | Polka dots, |
| Retro | inspired by past | trousers, A-line | sunglasses, | florals, checks, |
| | decades, often | skirts, 50s-style | vintage hats, | and bright, |
| | from the 1920s- | dresses, leather | pearl necklaces, | playful colors, or |
| | 1980s. | jackets, graphic | retro shoes. | pastels. |
| | | tees. | | |
| Grunge | 90s-inspired | Plaid flannel | Beanies, | Dark colors, |
| | rebellious style | shirts, ripped | chokers, layered | plaid patterns, |
| | with a mix of | jeans, band tees, | necklaces. | layered looks, |
| | punk, rock, and | oversized | | distressed |
| | thrift store | sweaters, combat | | textures. |
| | finds. | boots. | | |
| Chic (Chic & | Elegant, | Tailored trousers, | Statement | Black, beige, |
| Sophisticated) | fashion- | silk blouses, fitted | jewelry, scarves, | navy, and white, |
| | forward, and | dresses, designer | structured bags. | with occasional |
| | often | bags, heels. | | pops of bold |
| | minimalist yet | | | color or metallic |
| | polished and | | | accents. |
| | high-end. | | | |
| Punk | Rebellious and | Leather jackets, | Spiked collars, | Black, red, plaid, |
| | anti- | band tees, studded | chains, safety | dark colors, |
| | establishment | belts, ripped jeans, | pins. | occasional neon |
| | style with | plaid skirts, boots. | | accents. |
| | heavy DIY | | | |
| | influences. | | | |
| Luxury (High | Expensive, | Tailored suits, silk | Luxury jewelry, | Rich, opulent |
| Fashion) | exclusive, and | dresses, designer | high-end | colors (gold, |
| | high-end | handbags, high | sunglasses, | emerald, black, |
| | designer pieces. | heels, luxury | leather gloves. | deep navy), |
| | | watches. | | subtle patterns, |
| | | | | exclusive prints. |
| Feminine/Soft | Cute, girly, and | Ruffled blouses, | Hair clips, pearl | Pastels (pink, |
| | soft style, often | pleated skirts, | jewelry, dainty | lavender, baby |
| | with pastel | dresses, cardigans, | handbags. | blue), florals, |
| | tones and | ballet flats. | | polka dots, |
| | delicate fabrics. | | | gingham. |
| Masculine/ | A gender- | Button-up shirts, | Watches, ties, | Black, gray, |
| Androgynous | neutral style | trousers, blazers, | minimalistic | beige, white, |
| | that balances | oversized jackets, | jewelry, scarves. | plaid, stripes. |
| | masculine and | loafers, boots. | | |
| | feminine | | | |
| | elements. | | | |
| Eco-Friendly/ | Focus on | Organic cotton | Reusable bags, | Earthy tones, |
| Sustainable | clothing made | shirts, linen pants, | sustainable | natural dyes, and |
| | from eco- | upcycled | jewelry, | simple patterns. |
| | friendly or | accessories, hemp- | biodegradable | |
| | sustainable | based shoes. | footwear. | |
| | materials, often | | | |
| | minimalist in | | | |
| | design. | | | |
| K-Pop/ | A vibrant, | Colorful graphic | Statement | Bright, neon, |
| Harajuku | eclectic, and | tees, skirts, | earrings, bright | pastels, bold |
| | bold mix of | oversized jackets, | hair clips, | prints, and mixes |
| | colors and | platform shoes, | chunky | of textures. |
| | styles, | unique | sneakers. | |
| | influenced by | accessories. | | |
| | Japanese and | | | |
| | Korean fashion. | | | |

For the machine learning system 210 to understand and suggest outfits based on these styles, the machine learning system 210 can be provided with both style tags and attributes for each fashion item (e.g., as part of the prompt). One example of a suggested format for each fashion item can be:
Item: (e.g., t-shirt, blazer, dress)
Style(s): (e.g., Casual, Streetwear, Preppy)
Fit: (e.g., loose, tight, oversized, cropped)
Material: (e.g., cotton, denim, leather, silk, wool)
Color(s): (e.g., black, red, blue, green)
Pattern(s): (e.g., plain, striped, checkered, floral)
Accessories: (e.g., hat, jewelry, bag, belt)
Season: (e.g., Summer, Winter, Fall, Spring).

The template component 212 is configured to generate style templates that can be used by the machine learning system 210. In example embodiments, the template component 212 accesses images of outfits and indications of styles associated with the different outfits. The template component 212 can comprise an imaging component that identifies the different fashion items in the images, obtain metadata associated with each fashion item, and generate or update a corresponding style template based on the metadata. In embodiments where the machine learning system 210 can generate the style templates, the template component 212 is optional.

The complete look component 214 is configured to provide recommendations for completing a look for a fashion item that does not fit into any matched style outfits for a user. The machine learning model can indicate that a fashion item does not match with any of the other fashion items in the digital wardrobe (e.g., has a different style than the other fashion items). The complete look component 214 receives the indication of the fashion item that does not fit with any styles of matched style outfits (referred to as the non-matching item) and triggers a search of the publication system 116 for fashion items that match with a style of the non-matching item. The matching fashion items can then be suggested to the user by the complete look component 214. The user can decide whether to purchase a matching fashion item or sell the non-matching item. If the user decides to purchase the matching fashion item, the complete look component 214 places the matching fashion item in a cart and triggers the publication system 116 to complete the transaction.

If the user devices to sell the non-matching item, the sell component 216 is configured to mange a listing process for the non-matching item. Because the wardrobe assistant system 118 has all the metadata for the non-matching item, the sell component 216 can automatically, without any human input, generate a publication for the non-matching item. The publication can include one or more images, a description based on the metadata, and a price. The price can be based on metadata stored for the non-matching fashion item or the sell component 216 can identify a competitive price based on other publications associated with the publication system 116. The publication can be displayed to the user (e.g., via the interface component 202) for review. The user can edit the publication and/or approve the publication for publication. Once approved the sell component 216 provides the publication to the publication system 116 for publication.

In some embodiments, the sell component 216 can also suggest selling a fashion item that is underutilized. Because the fashion item is underutilized, the user may not like the fashion item anymore. In these cases, the user interface displayed to the user can include a section that indicates the underutilized fashion item that includes an option to sell the fashion item. Should the user decide to sell the fashion item, the sell component 216 can automatically generate the publication for selling the fashion item.

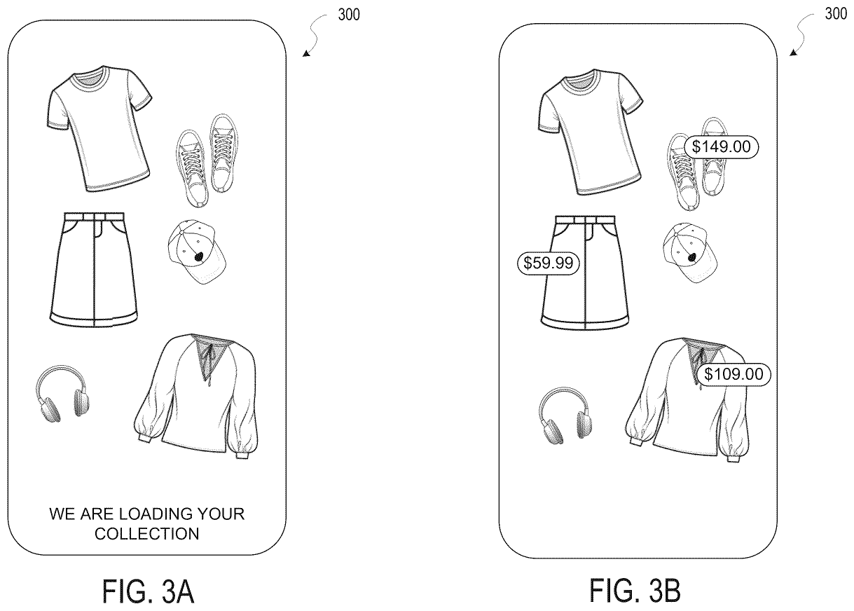

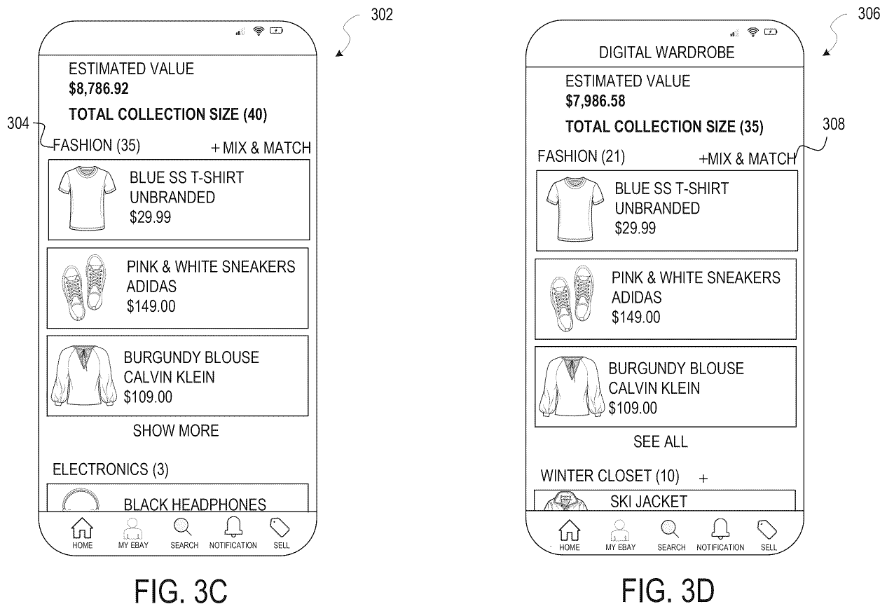

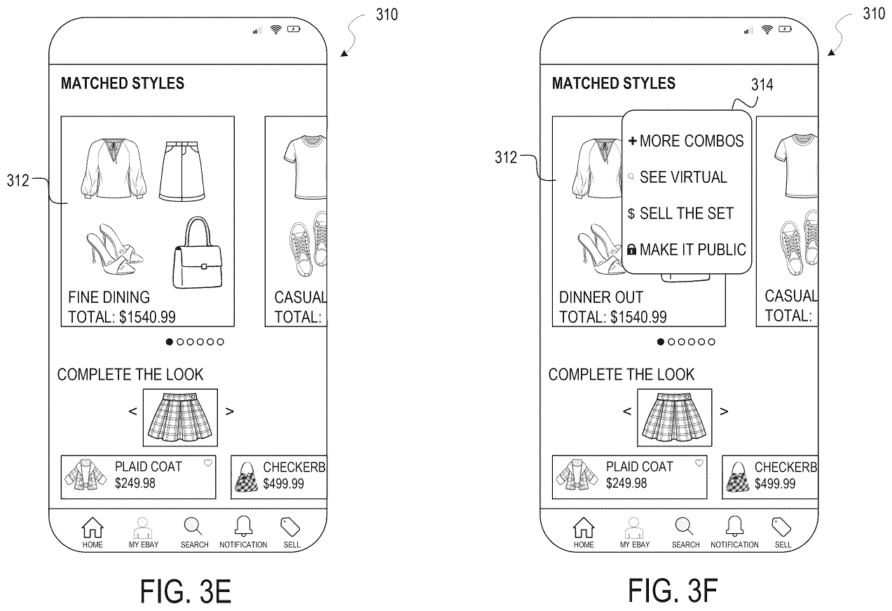

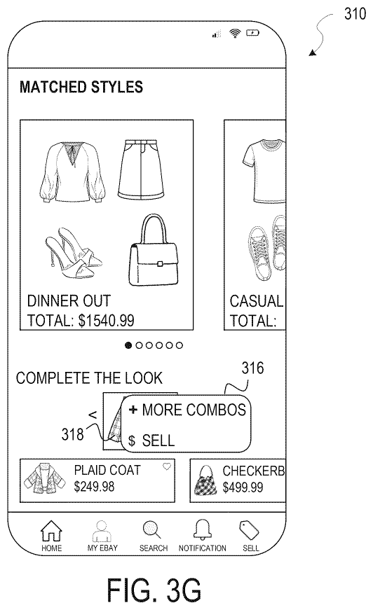

FIG. 3A-FIG. 3G illustrate example user interfaces illustrating operations associated with the wardrobe assistant system 118, according to example embodiments. The example comprises user interfaces that are displayed on the client device 106. In example embodiments, the user activates an application on the client device 106 that provides wardrobe assistance. The application allows the user to onboard items by capturing video via a camera of the client device 106. Referring to FIG. 3A, a live video of a plurality of items lying on a surface is displayed in a user interface 300 on the client device 106. The plurality of items include fashion items (e.g., t-shirt, sneakers, skirt, blouse, cap) and a non-fashion item (e.g., headphones). The live video is transmitted by the application to the wardrobe assistant system 118 (e.g., received by the interface component 202). Images of the live video can then be analyzed by the metadata component 204. While a live video is being used to onboard the items shown in the user interface 300, a still image captured by the client device 106 can also be used.

In example embodiments, as each fashion item is being captured in the live video, the metadata component 204 identifies each fashion item in the video and determines corresponding metadata or details about each fashion item. Alternatively, the user taps on (e.g., selects) a fashion item to trigger the metadata component 204 to identify the fashion item and its metadata. In some embodiments, the metadata component 204 can compare each image of a fashion item in the video to a database of images of identified fashion items to find a closest match. Corresponding metadata for the closest match is accessed and associated with the fashion item in the live video. In an alternative embodiment, the metadata component 204 can provide the image with a prompt to the machine learning system 210 (e.g., the evaluation component 220) and trigger the machine learning model to identify the fashion item and metadata.

In example embodiments, one or more of the metadata (e.g., details) can be displayed in substantially real-time over its corresponding fashion item. In one embodiment, the interface component 202 receives the one or more details/metadata and generates an overlay with the one or more details/metadata that is positioned over the corresponding fashion item in the live video. For example and referring now to FIG. 3B, a price is shown overlaid over the skirt, the blouse, and the sneakers. While price is displayed in the example, it is noted that displayed detail can be any metadata of the fashion item (e.g., a name of the fashion item). Any number of details can be overlaid over each fashion item and/or any number of fashion items can have an overlaid detail. In some embodiments, the items are automatically onboarded into the user's digital wardrobe. In other embodiments, the user can select (e.g., tap on) the item to add the fashion item to the digital wardrobe. Because the metadata can include the type of fashion item and other details, each fashion item can be automatically categorized. Each fashion item along with its corresponding metadata can be stored to a digital wardrobe of the user at the network system 102.

Any time after items have been onboarded to the user's digital wardrobe, the user can view their onboarded items. Referring now to FIG. 3C, a user interface 302 that shows all onboarded items in the user's collection is shown. The collection can include fashion items and non-fashion items (e.g., electronics). A total estimated value of the collection along with a number of items in the collection are shown at a top of the user interface. The items in the collection can be organized by categories. As shown, a fashion category contains 35 items and an electronics category contains three items.

The user can select the fashion category to view their digital wardrobe. For example, the user can tap on a fashion icon 304. Referring now to FIG. 3D, a user interface 306 showing the fashion items in the digital wardrobe is shown. Within the digital wardrobe, the fashion items can be organized into further subcategories. The example user interface 306 shows a fashion subcategory and a winter closet subcategory. Additionally, the total estimated value for the fashion item collection is shown.

For the fashion subcategory, an icon 308 is provided that triggers generation of matched style outfits. The selection of the icon 308 triggers the match component 208. In some cases, the user can select a fashion item and trigger generation of an outfit that includes that fashion item. In some cases, the user can indicate a style or an event that the user wants an outfit generated for. The match component 208 takes any inputs from the user (e.g., selected fashion item, indicated style, indicated event) and generates a prompt that includes the input(s), indication of fashion items in the digital wardrobe (or in the subcategory), and their corresponding metadata. In some cases, the prompt can include a style template and/or user preferences retrieved by the database component 206. The prompt is used to trigger a machine learning model to generate one or more matched style outfits.

FIG. 3E illustrates a user interface 310 showing matched style outfits generated by the machine learning model (e.g., the evaluation component 220). In a top portion of the user interface 310, a first matched style outfit 312 is shown. In example embodiments, an image of each fashion item in the first matched style outfit 312 is displayed. Also shown is a total price for the fashion items in the first matched style outfit 312 and a short description (e.g., fine dining).

In the present example, the user may have indicated an event (e.g., dinner out) or selected a fashion item (e.g., high heels) that they want an outfit created with. The indication can provide a style and a style template that will be used to generate the matched style outfit. Alternatively, if the user does not provide any guidance, the match component 208 can select a fashion item (e.g., a blouse) and generate an outfit that includes that fashion item and matches its style and/or use the user's preferences to generate the outfit. As shown, the first matched style outfit is for a style of fine dining.

In the present example, more than one matched style outfits are generated. As such, the user interface 310 is configured to allow the user to scroll on the top portion to view other matched style outfits.

Shown in a bottom portion of the user interface 310 is a “complete the look” section. This section displays a fashion item that may not match any styles of other fashion items in the digital wardrobe and/or any styles of the generated matched style outfits. The “complete the look” section will be discussed in more detail below.

The user has several options with respect to each displayed matched style outfit. Referring now to FIG. 3F, the user has right-clicked on the first matched style outfit 312. As a result, a pop-up window 314 (e.g., generated by the interface component 202) of options is displayed over the display of the first matched style outfit 312. The options can include seeing more matched style outfits (e.g., “more combos”), seeing the matched style outfit in a virtual try-on, selling the first matched style outfit 312 (e.g., “sell the set”), and making the matched style outfit public (e.g., posting to a social network). More, less, or other options can be included in the pop-up window 314.

If the user selects the option to see more matched style outfits, the match component 208 will trigger the machine learning model to generate more matched style outfits. In some embodiments, the additional matched style outfits will be in the same style at the first matched style outfit 312 (e.g., fine dining). In alternative embodiments, the additional matched style outfits can be in one or more different styles. In some cases, the user can select one or more of the fashion items in the first matched style outfit 312 to keep in the additional matched style outfits that are generated. For example, the user can indicate to keep the high heels in the additional matched style outfit.

If the user selects the option to see the matched style outfit in a virtual try-on, the application can trigger a camera on the client device 106 to capture an image (e.g. live video or photograph) of the user. The wardrobe assistant system 118 (e.g., the match component 208 and/or the interface component 202) then generates an overlay comprising the fashion items in the first matched style outfit 312. Because the wardrobe assistant system 118 has access to a database of metadata, including images of fashion items, the wardrobe assistant system 118 can use multiple images of each fashion item (e.g., from different angles) to generate the overlay. The overlay is then positioned over the image of the user. If the user is moving in the image, the wardrobe assistant system 118 can cause the images of the fashion items to move in a consistent manner as the user in the image. In an alternative embodiment, the user may have selected an avatar that is similar to the user (e.g., same body type, same dimensions). In this embodiment, the overlay is positioned over an image of the avatar.

If the user selects the option to sell the set, the wardrobe assistant system 118 (e.g., the sell component 216) can automatically generate corresponding publications for each of the fashion items in the first matched style outfit 312. Because the wardrobe assistant system 118 has all the metadata for the fashion items, the sell component 216 can automatically, without any human input, generate the publication for each fashion item. The publication can include one or more images, a description based on the corresponding metadata, and a price. In some embodiments, the publications are displayed to the user (e.g., via the interface component 202) for approval/editing before being published to the publication system 116. In other embodiments, the publication can be automatically published without user review and approval.

The selection of the “make it public” option triggers the match component 208 to post the first matched style outfit 312 to a social network. In some embodiments, the match component 208 simply posts the fashion items similar to how they are displayed in the user interface 310. In other embodiments, the match component 208 can post an image of the user with the matched style outfit positioned on the user or an image of a selected avatar with the matched style outfit positioned thereon. The post can elicit feedback from other users of the social network. The match component 208 can then present the feedback to the user (e.g., via a further user interface).

Referring now to FIG. 3G, the “complete the look” section is shown with selectable options in a pop-out window 316. As previously discussed, this section displays a fashion item 318 (e.g., a plaid skirt) that may not match any styles of other fashion items in the digital wardrobe and/or any styles of the generated matched style outfits (e.g., also referred to as a “non-matching item”). In example embodiments, the machine learning model can identify the non-matching fashion item (e.g., when generating the matched style outfits). The complete look component 214 receives an indication of the non-matching fashion item and triggers a search of the publication system 116 for available fashion items that match with a style of the non-matching item. The available matching fashion items are suggested to the user. Below the non-matching fashion item 318 are shown available fashion items that would complete the style look with the fashion item 318. For example, a plaid coat and a checkerboard purse are being suggested. There can be any number of available fashion items suggested that will complete the look. Thus, the user interface 310 allows the user to scroll along the images of the available fashion items. These available fashion items can be from the publication system 116.

If the user is interested in any of the available fashion items, the user can, in one embodiment, select the image of the available fashion item, which causes a display of details (e.g., metadata) regarding the selected, available fashion item. In some cases, the selection of the image will trigger display of a corresponding publication from the publication system 116. In another embodiment, a user can select an icon at a top of the image of the available fashion item (e.g., three dots) and be presented with a pop-out window providing various options such as, for example, viewing the corresponding publication, adding the available fashion item to a cart, or triggering a further search for items that are similar to the available fashion item.

A first option in the pop-out window 316 is to show more available fashion items (e.g., “more combos”). Selecting this option will trigger the complete look component 214 to search for more recommendations that will complete the look for the fashion item 318. In example embodiments, the complete look component 214 triggers another search of the publication system 116 for additional, available fashion items that match with the style of the non-matching item. The additional, available matching fashion items can then be displayed below the non-matching item 318 (e.g., replacing the previously suggested available matching fashion items).

A second option in the pop-out window 316 is to sell the non-matching fashion item. For instance, the user may decide that they do not want to purchase any further fashion items, does not have a need for the non-matching fashion item, and/or no longer wants the non-matching fashion item. If the user decides to sell the non-matching item, the sell component 216 triggers a listing process for the non-matching item. Because the wardrobe assistant system 118 has all the metadata for the non-matching item, the sell component 216 can automatically, without any human input, generate a publication for the non-matching item. The publication can include one or more images, a description based on the metadata, and a price. In some cases, the publication is displayed to the user (e.g., via the interface component 202) for review, whereby the user can edit the publication before approving it. In other cases, the publication can be automatically published to the publication system 116 without user review and/or approval.

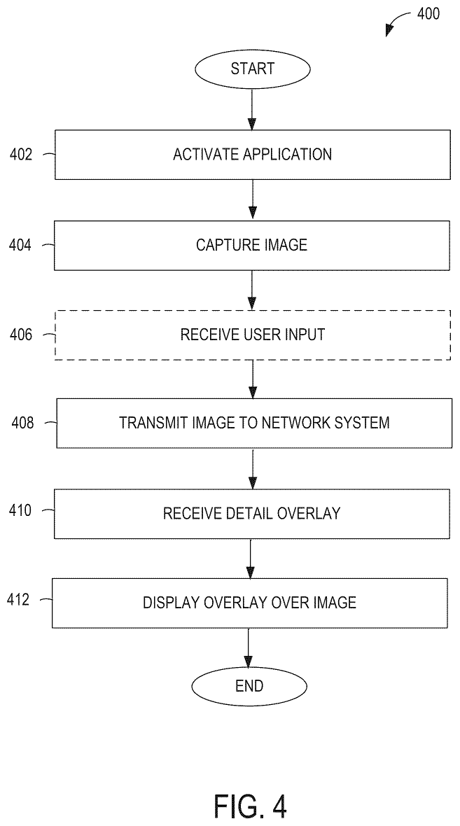

FIG. 4 is a flowchart illustrating a method 400 for onboarding items into a network system performed at the client device 106, according to example embodiments. Operations in the method 400 may be performed by the client device 106 (e.g., one or more applications on the client device 106). Accordingly, the method 400 is described by way of example with reference to the client device 106. However, it shall be appreciated that at least some of the operations of the method 400 may be deployed on various other hardware configurations or be performed by similar components residing elsewhere in the network environment 100. Therefore, the method 400 is not intended to be limited to the client device 106.

In operation 402, an application that provides wardrobe assistance is activated on the client device 106. The activated application allows the user to onboard items by capturing an image of items using a camera of the client device 106.

In operation 404, the camera captures the image of items that include fashion items. In some embodiments, the image comprises a live video of a plurality of items (e.g., hanging). In some embodiments, the image comprises a captured still image (e.g., photograph) of the plurality of items. In example embodiments, the image is displayed on the client device while it is being captured by the camera.

In operation 406, the application can receive one or more inputs from the user. For example, the user can indicate a style or category associated with one or more fashion items being onboarded. Operation 406 is optional and can occur any time after operation 404 (e.g., after operation 408).

In operation 408, the captured image is transmitted to network system 102. In example embodiments, the captured image is transmitted in substantially real-time as it is being captured. Thus, the activation of the application in operation 402 can establish a communication link, via the network 104, to the network system 102 such that the captured image is immediately transmitted as it is being captured.

In operation 410, the client device, via the application, receives a detail overlay that includes one or more metadata or details about one or more of the items in the image.

The overlay is also received in substantially real-time, such that it can be overlaid onto a live image (e.g., a live video).

In operation 412, application displays the overlay over the image. In example embodiments, the overlay is displayed such that metadata or detail(s) are positioned over their corresponding fashion item in the image. There can be more than one overlay (e.g., an overlay for each corresponding item) or a single overlay that comprises detail(s) for multiple fashion items.

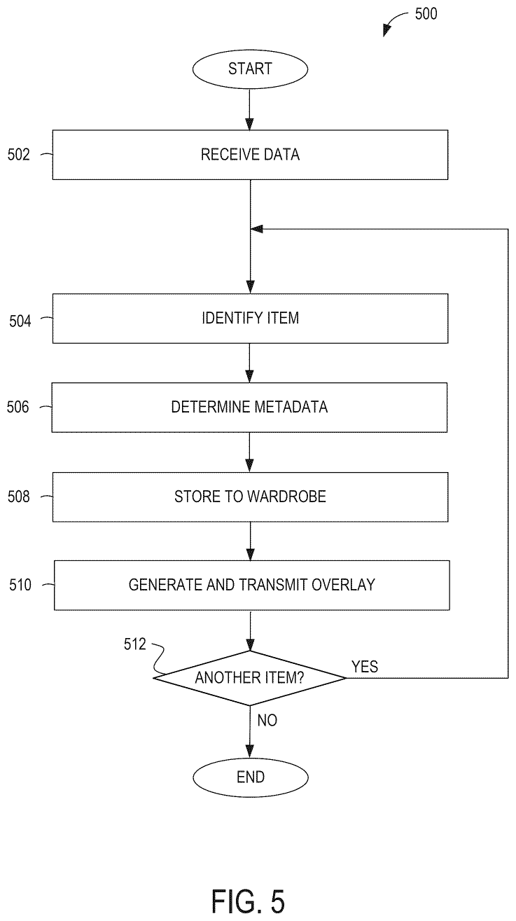

FIG. 5 is a flowchart illustrating a method 500 for onboarding items performed at the network system, according to example embodiments. Operations in the method 500 may be performed by the wardrobe assistant system 118. Accordingly, the method 500 is described by way of example with reference to the wardrobe assistant system 118 shown in FIG. 2. However, it shall be appreciated that at least some of the operations of the method 500 may be deployed on various other hardware configurations or be performed by similar components residing elsewhere in the network environment 100. Therefore, the method 500 is not intended to be limited to the wardrobe assistant system 118.

In operation 502, the interface component 202 receives data from the client device 106. The data includes a captured image that can be a live video of items to be onboarded to an account of the user at the network system 102. The items can comprise all fashion items or be a combination of fashion items and non-fashion items.

In operation 504, the metadata component 204 identifies a fashion item in the image. If the captured image contains more than one fashion item, the metadata component 204 can parse the captured image into individual images of each fashion item. In some embodiments, the metadata component 204 takes the image of a fashion item and compares it to a database of images of identified fashion items to find a closest match to identify the fashion item. In other embodiments, the metadata component 204 provides the image with a prompt to the evaluation component 220 and have the machine learning model identify the fashion item.

In operation 506, the metadata component 204 determines metadata or details for the fashion item. In some embodiments, once the closest match is identified, corresponding metadata for the matched identified fashion item is accessed from the database. In embodiments that use the machine learning model, the metadata is determined by the machine learning model. The metadata can include, for example, one or more images, a category, an item type, colors, patterns, textures, a brand, a price (e.g., average sales price, manufacturer recommended price), a corresponding style, and/or any other type of attribute that describes the identified fashion item.

In operation 508, the identified fashion item from the image and corresponding metadata are stored to a digital wardrobe associated with the user. In example embodiments, the database component 206 stores the metadata for the fashion item in the user's digital wardrobe (e.g., to a user profile of the user) at the network system 102.

In operation 510, the wardrobe assistant system 118 generates and transmits an overlay that includes one or more details (e.g., metadata) for the fashion item. In example embodiments, the interface component 202 receives the one or more details (e.g., from the metadata component 204) and generates the overlay. The overlay can be positioned over the corresponding fashion item in the live video. As such, the overlay is transmitted back to the client device 106 by the interface component 202 with instructions to position the overlay accordingly. This generating and transmitting of the overlay occurs in substantially real-time with the capturing and receiving of the image. This allows for the overlay to be position over a live image of the same fashion items.

A determination is made, in operation 512, whether there is a further fashion item detected in the image (e.g., another individual image parsed from the captured image). If a further fashion item is detected, than the method 500 returns to operation 504 where the further fashion item is identified, and corresponding metadata is determined (operation 506).

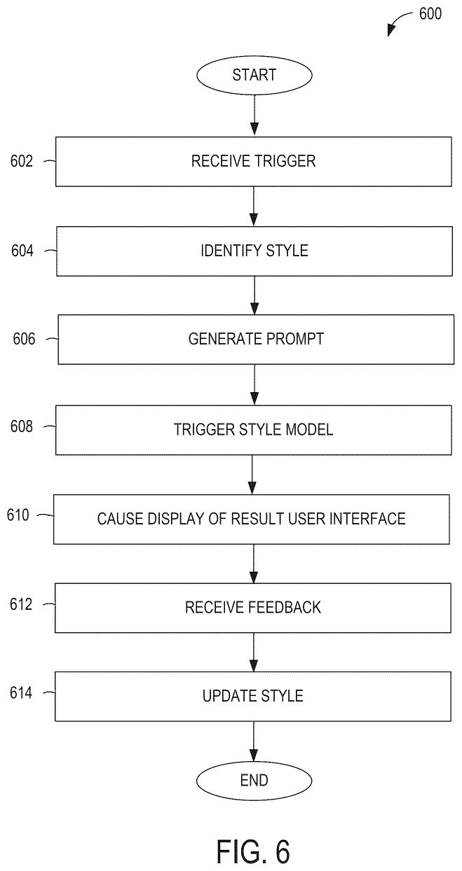

FIG. 6 is a flowchart illustrating a method 600 for providing digital wardrobe assistance in generating matched style outfits, according to example embodiments. Operations in the method 600 may be performed by the wardrobe assistant system 118. Accordingly, the method 600 is described by way of example with reference to the wardrobe assistant system 118 shown in FIG. 2. However, it shall be appreciated that at least some of the operations of the method 600 may be deployed on various other hardware configurations or be performed by similar components residing elsewhere in the network environment 100. Therefore, the method 600 is not intended to be limited to the wardrobe assistant system 118.

In operation 602, the wardrobe assistant system 118 (e.g., interface component 202) receives a trigger to generate matched style outfits. For example, the user can select an icon displayed on their client device 106 that triggers the generation of matched style outfits. The selection of this icon is detected by the interface component 202, which then triggers the match component 208.

In operation 604, a style for the matched style outfit is identified by the match component 208. In some cases, the style is received from the client device based on a user selection. In some cases, an indication of an event is received from the client device. The style can then be identified from the event by the match component 208. For example, if the event is a formal wedding, then the style can be formal attire. In some cases, the style can be identified based on a selected fashion item. For example, the user can select a fashion item they want included in the matched style outfit or can select a fashion item that the user wants the style of. In another embodiment, the match component 208 can select a fashion item from the digital wardrobe with which to generate matched style outfits.

In further cases, the style can be selected by the match component 208 based on the preferences of the user. The user preferences can include styles or previously generated outfits that the user has indicated as not liking or liking. These user preferences can be learned by the machine learning model and associated with the account of the user. In some embodiments, a personal style template is generated and updated by the machine learning model that reflects the user preferences.

In operation 606, the match component 208 generates a prompt for triggering the machine learning model (e.g., style model) to generate one or more matched style outfits. In embodiments where a machine learning model is trained on different styles, the prompt can include, for example, an indication to generate one or more matched style outfits using the user's digital wardrobe, an indication of the fashion items in the digital wardrobe, the style identified in operation 604, and any user preferences (e.g., a personal style template). In embodiments where the machine learning model is not already trained on styles, the prompt can include, for example, an indication to generate one or more matched styles using the user's digital wardrobe, an indication of the fashion items in the digital wardrobe, any user preferences (e.g., personal style template), and a style template based on the style identified in operation 604. In some cases, the prompt can also include a fashion item selected from the digital wardrobe that should be included in the matched style outfit (e.g., a fashion item that the user indicated they wanted to wear). Furthermore, the prompt can include instructions to identify any fashion items that do not match with other fashion items in the digital wardrobe.

In operation 608, the machine learning model (e.g., a style model) is triggered to generate matched style outfits. In example embodiments, the evaluation component 220 receives the prompt generated in operation 606. The prompt is them presented to the machine learning model. The evaluation component 220 obtains results that include one or more matched style outfits and, in some cases, identification of a non-matching fashion item.

In operation 610, the wardrobe assistant system 118 causes display of a result user interface on the client device 106. In example embodiments, the results of the machine learning system 210 are provided back to the match component 208 by the evaluation component 220. The match component 208 then works with the interface component 202 to generate and cause display of the result user interface. An example of the result user interface is show in FIG. 3E.

In operation 612, the wardrobe assistant system 118 can receive feedback from the user device 106. For example, the user can indicate whether they like a matched style outfit, do not like the matched style outfit, or if they want more matched style outfits generated.

In operation 614, a personal style temple of the user is updated based on the feedback. When the user indicates a like or dislike, the match component 208 registers that indication and can trigger an update to user preferences. For example, the user preference can indicate to never show the disliked outfit and/or corresponding style again. Conversely, if the user likes a generated outfit, the user preferences can be updated to indicate a preference for the style associated with the liked outfit. These user preferences can be included in the personal style template of the user which is updated by the subsequent feedback.

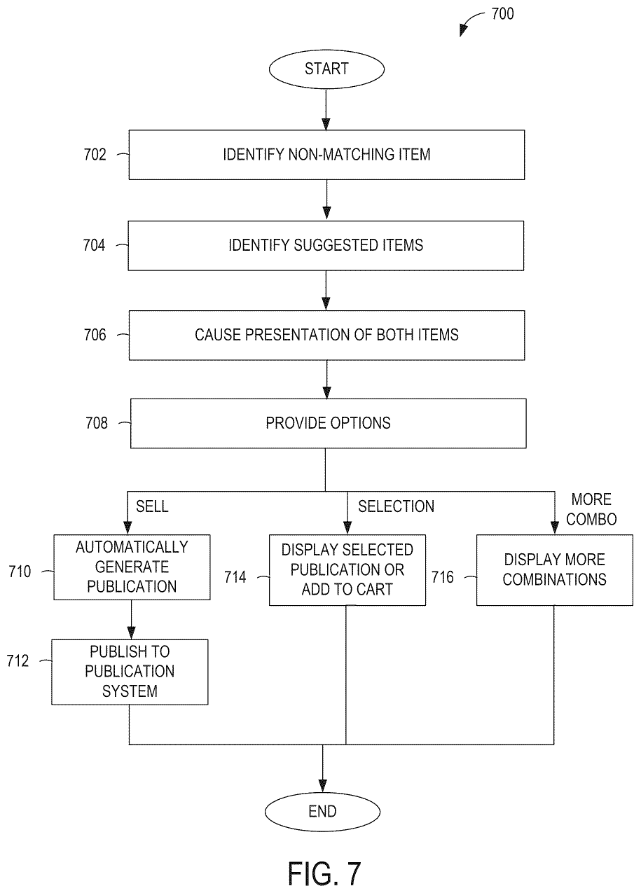

FIG. 7 is a flowchart illustrating a method 700 for handling a non-matching fashion item, according to example embodiments. Operations in the method 700 may be performed by the wardrobe assistant system 118. Accordingly, the method 700 is described by way of example with reference to the wardrobe assistant system 118 shown in FIG. 2. However, it shall be appreciated that at least some of the operations of the method 700 may be deployed on various other hardware configurations or be performed by similar components residing elsewhere in the network environment 100. Therefore, the method 700 is not intended to be limited to the wardrobe assistant system 118.

In operation 702, a non-matching fashion item is identified. In example embodiments, when the machine learning model (e.g., a style model) is triggered to generate matched style outfits, it can also identify the non-matching fashion item. The non-matching fashion item can be a fashion item that does not match with any of the other fashion items in the digital wardrobe (e.g., has a different style than the other fashion items) and/or cannot be used in generating matched style outfits.

In operation 704, suggested items that can complete a look with the non-matching fashion item (e.g., are of the same style and will complement the non-matching fashion item) are identified. In example embodiments, the complete look component 214 receives the indication of the non-matching fashion item and triggers a search of the publication system 116 for fashion items that match with the style of the non-matching fashion item. For example, the complete look component 214 can generate a search query associated with the non-matching fashion item and transmits the search query to the publication system 116.

In operation 706, the complete look component 214 causes presentation of the non-matching item and the suggested items. In example embodiments, the non-matching item and the suggested items can be presented as part of the result user interface. An example of the result user interface is shown in FIG. 3E.

In operation 708, the complete look component 214 can provide different options with respect to the non-matching fashion item. The options can be displayed in response to a user selection (e.g., right-click on the non-matching fashion item image) and can include seeing more combinations of suggested items, purchasing one or more suggested items, and/or selling the non-matching fashion item.

If the user selects the option to sell the non-matching fashion item, then in operation 710, a publication is automatically generated. In example embodiments, the sell component 216 manages a listing process for the non-matching item including automatically, without any human input, generating a publication for the non-matching item using the metadata associated with the non-matching fashion item stored to the user's account. The publication can include one or more images, a description based on the metadata, and a price.

In operation 712, the publication is published to the publication system 116. In some cases, the publication is displayed to the user (e.g., via the interface component 202) for review and/or editing. Once approved the sell component 216 provides the publication to the publication system 116 for publication. In other cases, the publication is automatically published without user approval.

If the user selects a suggested item (e.g., clicks on an image of the suggested item), the wardrobe assistant system 118 can, in one embodiment, display a publication corresponding to the suggested item in operation 714. In another embodiment, selection of the suggested item causes the suggested item to be added to a cart in operation 714. The user can then add more suggested items or proceed to purchase the item(s) in the cart.

If the user selects an option to show more combinations, the wardrobe assistant system 118 obtains and displays further suggested items in operation 716. In example embodiments, the complete look component 214 will search for more recommendations that will complete the look for the fashion item 318. For example, the complete look component 214 can trigger another search of the publication system 116 for additional, available fashion items that match with the style of the non-matching item. The additional, available matching fashion items can then be displayed on the client device 106 (e.g., replacing the previously suggested available matching fashion items).

While the above embodiments have been discussed above using a categorical approach to generate matched style outfits (e.g., outfits generated based on a specific style), alternative embodiments can use other approaches can be used that can allow for a more nuanced and flexible recommendation system. These alternative approaches include color theory, occasion-based, body shape and type, mood, seasonal, material-based, high/low fashion mixing, trend-based, cultural/regional style, aesthetic subculture mixing, time-of-day, sustainable fashion, or any combination of these.

Color theory matching is based on a concept that colors complement each other and can create aesthetic harmony. An approach for color theory matching is that fashion items can be paired based on complementary, analogous, or triadic color schemes. Complementary Colors are colors on opposite sides of the color wheel (e.g., red and green), while analogous colors are colors that are next to each other on the color wheel (e.g., blue, green, and teal), and triadic colors are colors that are evenly spaced around the color wheel (e.g., red, yellow, and blue). For color theory matching, the machine learning system 210 can analyze the color palette of each fashion item and match them based on principles of color harmony.

Occasion-based matching is based on an occasion or activity the user is dressing for (e.g., work, casual outing, wedding, date night). Thus, each outfit is categorized by its suitability for different settings and activities. A formal occasion can include, for example, a meeting, business dinner, or wedding, while a casual occasion are for everyday wear, hangouts, or weekending outings. Other examples of occasions can be athletic which includes workouts, sports, or casual comfort and a night out which can entail clubbing evening parties, or dates. For occasion-based matching, the machine learning system 210 can use occasion tags like “date,” “party,” or “work” to suggest outfits that align with a specific need, mixing and matching pieces according to the event's formality level.

Body shape/type matching suggests outfits based on body type to enhance or balance proportions. People have different body shapes (e.g., pear-shaped, apple-shaped, hourglass, etc.), and certain styles flatter specific body types. For example, an hourglass shape will emphasize fitted dresses, belts at the waist, and tailored cuts, while a pear-shape will emphasize A-line skirts, empire waist dresses, and bright tops. An apple-shape will use empire waist, tunic tops, and straight-legged pants, while a rectangle shape will use belts to create curves, layered outfits, and straight-leg pants. For body shape/type matching, the user inputs their body type or select it through a guided process. The machine learning system 210 then suggests fashion items that accentuate their best features and provide a flattering silhouette.

Matching based on mood or emotions is based on the idea that clothes can reflect or improve a person's mood or emotional state. Outfits are suggested based on the user's current mood or desired feeling (e.g., confident, happy, cozy, energetic). For example, a comfortable mood can emphasize oversized sweaters, leggings, and slippers, while a confident/powerful mood can emphasize bold colors and structured clothing like suits or blazers. In further examples, a relaxed/chill mood will use soft fabrics, muted tones, and loungewear, while a fun/playful mood can use bright colors, quirky prints, and youthful cuts. For mood/emotional-state matching, the user can input how they feel or want to feel, and the machine learning system 210 suggests an outfit based on color psychology and fabric choices that match or improve their mood.

Seasonal matching generates outfits that are suitable for different seasons (e.g., summer, winter, fall, spring). In this embodiments, fashion items are tagged by seasonality, and the machine learning system 210 can suggest outfits based on a current season or the user's location (e.g., it can be summer in one hemisphere and winter in another). For summer, light fabrics like linen and cotton, shorts, skirts, and sandals can be used. For winter, heavy fabrics like wool, down jackets, scarves, boots, sweaters are used. Fall will emphasize layering pieces, trench coats, cardigans, and darker tones. Finally, spring can use floral prints, light jackets, and breathable fabrics. In this embodiment, location data or user preferences can be used by the machine learning system 210 to suggest season-appropriate clothing, considering both temperature and style trends.

Fabric/material-based matching is based on similar or complementary fabrics. Accordingly, outfits are suggested that are made of similar fabrics or materials that complement each other's texture. For example, cotton and denim are casual, comfortable, and breathable, while leather and silk are an edgy yet elegant combination. In a further example, wool and cashmere are luxe, warm, and cozy. By analyzing the fabric type and texture of each fashion item, the machine learning system 210 can suggest items that either harmonize or create interesting contrasts (e.g., pairing a soft wool sweater with a sleek leather jacket).

In mixing high and low fashion, the idea is combining expensive, high-end designer pieces with more affordable, everyday wear to create a balanced outfit. Here, the machine learning system can suggest an outfit that combines “luxury” pieces (like a designer handbag or coat) with more budget-friendly items (like a simple T-shirt or jeans). For example, a designer handbag can be combined with a casual dress and sneakers. Here the fashion items are tagged items as either “luxury” or “affordable” (e.g., based on the metadata). The machine learning system 210 can then suggestds balanced combinations that blend both worlds.

Trend-based matching suggests outfits based on current fashion trends or seasonal runway looks (e.g., neon colors, oversized blazers, athleisure, cottagecore). For example, a trendy oversized blazer can be combined with baggy jeans for a street-style look. In this embodiment, the wardrobe assistant system 118 can track fashion trends from social media, magazines, or even fashion runways and integrate this data into its suggestions, keeping the user on-trend.

Cultural or regional style matching provides outfits based on cultural or regional styles and traditional dress. Here, the wardrobe assistant system 118 can suggest pieces influenced by cultural heritage (e.g., Japanese kimono-inspired jackets, African prints, Indian saris, or Scandinavian minimalist designs). As an example, a sleek, minimalist Scandinavian-style dress can be paired with a bold, ethnic statement necklace. In this embodiment, cultural and regional tags (e.g., based on the metadata) can be used to create a more global and eclectic approach to matching styles.

Mixing different aesthetic subcultures comprises combining elements from different fashion subcultures to create unique, eclectic looks (e.g., mixing goth with grunge or streetwear with preppy). Here, outfits can be suggestd that are unexpected combinations of different aesthetics to create personalized and avant-garde outfits. For example, a gothic choker can be paired with a preppy blazer, or punk elements (e.g., studs) can be mixed with bohemian fabrics (like fringes). In this embodiment, the wardrobe assistant system 118 can use style tags and pattern recognition to match pieces from different subcultures while maintaining visual harmony.

Time-of-day matching suggests outfits based on the time of day and the activities the user is likely to engage in. Different pieces of clothing are appropriate for different times of the day. For example, daytime can incude light, breathable fabrics and casual styles, while evening can include darker, more formal attire and dressier materials. As a further example, night can include bold, glamorous outfits for a night out. Here, the wardrobe assistant system 118 can track the time of day or user preferences for morning, afternoon, and evening and recommend accordingly.

Sustainable/ethical fashion matching suggests outfits based on sustainability criteria (e.g., ethical production, eco-friendly materials, secondhand items). Here, fashion items that meets certain sustainable standards, such as recycled materials or eco-friendly brands are prioritized. For example, an outfit made entirely from sustainable materials like organic cotton or hemp can be suggested. In example embodiments, users interested in sustainability can opt for eco-conscious outfit recommendations based on brand, fabric type, or manufacturing process.

The above approaches do not have to be mutually exclusive. For example, the wardrobe assistant system 118 can match outfits based on style, but also consider seasonality, color theory, and mood, blending multiple matching criteria for more personalized and dynamic outfit suggestions. By giving the user the option to input preferences (e.g., casual but trendy, formal yet bold), example embodiments can intelligently combine these factors for unique and diverse outfit ideas.

FIG. 8 illustrates components of a machine 800, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part.

For example, the instructions 824 may cause the machine 800 to execute the flow diagrams of FIG. 4 to FIG. 7. In one embodiment, the instructions 824 can transform the machine 800 into a particular machine (e.g., specially configured machine) programmed to carry out the described and illustrated functions in the manner described.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more components described herein.

The machine 800 may further include a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also include an input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 includes a machine-storage medium 822 (e.g., a tangible machine-storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-storage media (e.g., tangible and non-transitory machine-storage media). The instructions 824 may be transmitted or received over a network 826 via the network interface device 820.

In some example embodiments, the machine 800 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 822 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communications network 826 using a transmission medium via the network interface device 820 and utilizing any one of a number of well-known transfer protocols (e.g., HTTP). Examples of communication networks 826 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for managing a digital wardrobe using machine learning technology. The method comprises receiving, via a mobile device of a user, a live video of a plurality of fashion items; identifying each fashion item of the plurality of fashion items in the live video; determining details for each fashion item in the live video in real-time, the details including a description of each identified fashion item; causing display of one of the details overlaid over at least one fashion item in the live video; storing the plurality of fashion items and their corresponding details in a digital wardrobe associated with an account of the user; based on the plurality of fashion items and their corresponding details, generating, by a style model, a matched style outfit using two or more of the plurality of fashion items from the digital wardrobe; and causing display of the matched style outfit in a user interface.
In example 2, the subject matter of example 1 can optionally include wherein causing display of the matched style outfit comprises capturing a live image of the user in a mirror; and positioning images of the two or more of the plurality of fashion items of the matched style outfit on the live image of the user, wherein the images of the two or more of the plurality of fashion items of the matched style outfit move with the live image of the user.
In example 3, the subject matter of any of examples 1-2 can optionally include publishing the matched style outfit to a social media platform; receiving feedback from the social media platform; and causing presentation of the feedback to the user.
In example 4, the subject matter of any of examples 1-3 can optionally include identifying a fashion item that does not fit with a style of the matched style outfit; performing a search on a publication system for other items that can be combined with the fashion item that does not fit with the style of the matched style outfit; and causing presentation of images of the other items for consideration by the user.
In example 5, the subject matter of any of examples 1-4 can optionally include identifying a fashion item that does not fit with a style of the matched style outfit or other items in the digital wardrobe; and causing display of a suggestion to sell the fashion item that does not fit.
In example 6, the subject matter of any of examples 1-5 can optionally include wherein the generating the matched style outfit comprises receiving a selection of a fashion item from the digital wardrobe; receiving an indication to generate the matched style outfit that includes the selected fashion item; and in response to the indication, triggering the style model to generate the matched style outfit that includes the selected fashion item in combination with other fashion items from the digital wardrobe.
In example 7, the subject matter of any of examples 1-6 can optionally include wherein generating the matched style outfit comprises receiving an indication of an event or trend; generating a prompt that indicates the event or trend; and using the prompt, triggering the style model to generate the matched style outfit using the digital wardrobe.
In example 8, the subject matter of any of examples 1-7 can optionally include analyzing a wear frequency for each fashion item in the digital wardrobe; and generating a match style outfit based on the wear frequency for each fashion item to optimize wardrobe utility.
In example 9, the subject matter of any of examples 1-8 can optionally include receiving feedback from the user regarding the matched style outfit; and based on the feedback, retraining the style model to identify user preferences used to generate matched style outfits.
In example 10, the subject matter of any of examples 1-9 can optionally include generating a prompt that comprises a fashion style associated with the user and instructions to generate the matched style outfit using the digital wardrobe, wherein the style model is triggered by the prompt to generate the matched style outfit.
In example 11, the subject matter of any of examples 1-10 can optionally include identifying one or more styles associated with the user based on the details of the plurality of fashion items.
In example 12, the subject matter of any of examples 1-11 can optionally include receiving a selection of an avatar that represents the user, wherein causing display of the matched style outfit comprises displaying the matched style outfit on the avatar.
Example 13 is a system for managing a digital wardrobe using machine learning technology. The system comprises one or more processors and a memory storing instructions that, when executed by the one or more processors, cause the one or more processors to perform operations comprising receiving, via a mobile device of a user, a live video of a plurality of fashion items; identifying each fashion item of the plurality of fashion items in the live video; determining details for each fashion item in the live video in real-time, the details including a description of each identified fashion item; causing display of one of the details overlaid over at least one fashion item in the live video; storing the plurality of fashion items and their corresponding details in a digital wardrobe associated with an account of the user; based on the plurality of fashion items and their corresponding details, generating, by a style model, a matched style outfit using two or more of the plurality of fashion items from the digital wardrobe; and causing display of the matched style outfit in a user interface.
In example 14, the subject matter of example 13 can optionally include wherein causing display of the matched style outfit comprises capturing a live image of the user in a mirror; and positioning images of the two or more of the plurality of fashion items of the matched style outfit on the live image of the user, wherein the images of the two or more of the plurality of fashion items of the matched style outfit move with the live image of the user.
In example 15, the subject matter of any of examples 13-14 can optionally include wherein the operations further comprise identifying a fashion item that does not fit with a style of the matched style outfit; performing a search on a publication system for other items that can be combined with the fashion item that does not fit with the style of the matched style outfit; and causing presentation of images of the other items for consideration by the user.
In example 16, the subject matter of any of examples 13-15 can optionally include wherein the operations further comprise identifying a fashion item that does not fit with a style of the matched style outfit or other items in the digital wardrobe; and causing display of a suggestion to sell the fashion item that does not fit.
In example 17, the subject matter of any of examples 13-16 can optionally include wherein the generating the matched style outfit comprises receiving a selection of a fashion item from the digital wardrobe; receiving an indication to generate the matched style outfit that includes the selected fashion item; and in response to the indication, triggering the style model to generate the matched style outfit that includes the selected fashion item in combination with other fashion items from the digital wardrobe.
In example 18, the subject matter of any of examples 13-17 can optionally include wherein generating the matched style outfit comprises receiving an indication of an event or trend; generating a prompt that indicates the event or trend; and using the prompt, triggering the style model to generate the matched style outfit using the digital wardrobe.
In example 19, the subject matter of any of examples 13-18 can optionally include wherein the operations further comprise receiving feedback from the user regarding the matched style outfit; and based on the feedback, retraining the style model to identify user preferences used to generate matched style outfits.
Example 20 is a machine-storage medium comprising instructions which, when executed by one or more processors of a machine, cause the machine to perform operations for managing a digital wardrobe using machine learning technology. The operations comprise receiving, via a mobile device of a user, a live video of a plurality of fashion items; identifying each fashion item of the plurality of fashion items in the live video; determining details for each fashion item in the live video in real-time, the details including a description of each identified fashion item; causing display of one of the details overlaid over at least one fashion item in the live video; storing the plurality of fashion items and their corresponding details in a digital wardrobe associated with an account of the user; based on the plurality of fashion items and their corresponding details, generating, by a style model, a matched style outfit using two or more of the plurality of fashion items from the digital wardrobe; and causing display of the matched style outfit in a user interface.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
receiving, via a mobile device of a user, a live video of a plurality of fashion items; identifying each fashion item of the plurality of fashion items in the live video;
determining details for each fashion item in the live video in real-time, the details including a description of each identified fashion item;
causing display of one of the details overlaid over at least one fashion item in the live video;
storing the plurality of fashion items and their corresponding details in a digital wardrobe associated with an account of the user;
based on the plurality of fashion items and their corresponding details, generating, by a style model, a matched style outfit using two or more of the plurality of fashion items from the digital wardrobe; and
causing display of the matched style outfit in a user interface.

2. The method of claim 1, wherein causing display of the matched style outfit comprises:
capturing a live image of the user in a mirror; and
positioning images of the two or more of the plurality of fashion items of the matched style outfit on the live image of the user, wherein the images of the two or more of the plurality of fashion items of the matched style outfit move with the live image of the user.

3. The method of claim 1, further comprising:
publishing the matched style outfit to a social media platform;
receiving feedback from the social media platform; and
causing presentation of the feedback to the user.

4. The method of claim 1, further comprising:
identifying a fashion item that does not fit with a style of the matched style outfit;
performing a search on a publication system for other items that can be combined with the fashion item that does not fit with the style of the matched style outfit; and
causing presentation of images of the other items for consideration by the user.

5. The method of claim 1, further comprising:
identifying a fashion item that does not fit with a style of the matched style outfit or other items in the digital wardrobe; and
causing display of a suggestion to sell the fashion item that does not fit.

6. The method of claim 1, wherein the generating the matched style outfit comprises:
receiving a selection of a fashion item from the digital wardrobe;
receiving an indication to generate the matched style outfit that includes the selected fashion item; and
in response to the indication, triggering the style model to generate the matched style outfit that includes the selected fashion item in combination with other fashion items from the digital wardrobe.

7. The method of claim 1, wherein generating the matched style outfit comprises:
receiving an indication of an event or trend;
generating a prompt that indicates the event or trend; and
using the prompt, triggering the style model to generate the matched style outfit using the digital wardrobe.

8. The method of claim 1, further comprising:
analyzing a wear frequency for each fashion item in the digital wardrobe; and
generating a match style outfit based on the wear frequency for each fashion item to optimize wardrobe utility.

9. The method of claim 1, further comprising:
receiving feedback from the user regarding the matched style outfit; and
based on the feedback, retraining the style model to identify user preferences used to generate matched style outfits.

10. The method of claim 1, further comprising:
generating a prompt that comprises a fashion style associated with the user and instructions to generate the matched style outfit using the digital wardrobe, wherein the style model is triggered by the prompt to generate the matched style outfit.

11. The method of claim 1, further comprising:
identifying one or more styles associated with the user based on the details of the plurality of fashion items.

12. The method of claim 1, further comprising:
receiving a selection of an avatar that represents the user, wherein causing display of the matched style outfit comprises displaying the matched style outfit on the avatar.

13. A system comprising:
one or more processors; and
a memory storing instructions that, when executed by the one or more processors, cause the one or more processors to perform operations comprising:
receiving, via a mobile device of a user, a live video of a plurality of fashion items; identifying each fashion item of the plurality of fashion items in the live video;
determining details for each fashion item in the live video in real-time, the details including a description of each identified fashion item;
causing display of one of the details overlaid over at least one fashion item in the live video;
storing the plurality of fashion items and their corresponding details in a digital wardrobe associated with an account of the user;
based on the plurality of fashion items and their corresponding details, generating, by a style model, a matched style outfit using two or more of the plurality of fashion items from the digital wardrobe; and
causing display of the matched style outfit in a user interface.

14. The system of claim 13, wherein causing display of the matched style outfit comprises:
capturing a live image of the user in a mirror; and
positioning images of the two or more of the plurality of fashion items of the matched style outfit on the live image of the user, wherein the images of the two or more of the plurality of fashion items of the matched style outfit move with the live image of the user.

15. The system of claim 13, wherein the operations further comprise:
identifying a fashion item that does not fit with a style of the matched style outfit;
performing a search on a publication system for other items that can be combined with the fashion item that does not fit with the style of the matched style outfit; and
causing presentation of images of the other items for consideration by the user.

16. The system of claim 13, wherein the operations further comprise:
identifying a fashion item that does not fit with a style of the matched style outfit or other items in the digital wardrobe; and
causing display of a suggestion to sell the fashion item that does not fit.

17. The system of claim 13, wherein the generating the matched style outfit comprises:
receiving a selection of a fashion item from the digital wardrobe;
receiving an indication to generate the matched style outfit that includes the selected fashion item; and
in response to the indication, triggering the style model to generate the matched style outfit that includes the selected fashion item in combination with other fashion items from the digital wardrobe.

18. The system of claim 13, wherein generating the matched style outfit comprises:
receiving an indication of an event or trend;
generating a prompt that indicates the event or trend; and
using the prompt, triggering the style model to generate the matched style outfit using the digital wardrobe.

19. The system of claim 13, wherein the operations further comprise:
receiving feedback from the user regarding the matched style outfit; and
based on the feedback, retraining the style model to identify user preferences used to generate matched style outfits.

20. A machine-storage medium comprising instructions which, when executed by one or more processors of a machine, cause the machine to perform operations comprising:
receiving, via a mobile device of a user, a live video of a plurality of fashion items; identifying each fashion item of the plurality of fashion items in the live video;
determining details for each fashion item in the live video in real-time, the details including a description of each identified fashion item;
causing display of one of the details overlaid over at least one fashion item in the live video;
storing the plurality of fashion items and their corresponding details in a digital wardrobe associated with an account of the user;
based on the plurality of fashion items and their corresponding details, generating, by a style model, a matched style outfit using two or more of the plurality of fashion items from the digital wardrobe; and
causing display of the matched style outfit in a user interface.
